(19) United States
(12) Patent Application Publication
(10) Pub. No.: US 2018/0197650 A1
(43) Pub. Date: Jul. 12, 2018

(54) ALUMINUM ALLOY CONDUCTIVE WIRE, AND ELECTRICAL WIRE AND WIRE HARNESS USING THE SAME

(71) Applicant: FUJIKURA LTD., Tokyo (JP)

(72) Inventor: Tatsunori Shinoda, Chiba (JP)

(73) Assignee: FUJIKURA LTD., Tokyo (JP)

(21) Appl. No.: 15/746,374

(22) PCT Filed: Jul. 27, 2016
(86) PCT No.: PCT/JP2016/071976

§ 371 Date: Jan. 19, 2018

(30) Foreign Application Priority Data
Jul. 29, 2015 (JP) 2015-149662
Apr. 25, 2016 (JP) 2016-086712

(51) Int. Cl. H01B 1/02; C22C 21/00; H01B 5/02; H01B 7/00; C22F 1/04

(52) U.S. Cl. CPC H01B 1/023; C22C 21/00; C22F 1/04; H01B 7/0045; H01B 5/02

(57) ABSTRACT

An aluminum alloy conductive wire contains 0.15 mass % or more and 0.25 mass % or less of Si; 0.6 mass % or more and 0.9 mass % or less of Fe; 0.05 mass % or more and 0.15 mass % or less of Cu; 0.3 mass % or more and 0.55 mass % or less of Mg; and 0.015 mass % or less in total of Ti, V, and B. The aluminum alloy conductive wire has tensile strength of 170 MPa or less, and an average crystal grain size of 5μm or less.

### TECHNICAL FIELD

The present invention relates to an aluminum alloy conductive wire, and an electrical wire and a wire harness using the same.

### BACKGROUND ART

In recent years, an aluminum alloy conductive wire has been used as a conductive wire instead of a copper wire in an electrical wire of a wire harness used for an opening-closing portion such as a vehicle door, a portion around a vehicle engine or the like.

For example, an aluminum alloy conductive wire, which contains Mg, Si, and at least one element selected from Cu, Fe, Cr, Mn and Zr and has tensile strength of 150 MPa or more and a maximum crystal grain size of 50 μm or less, has been known as such an aluminum alloy conductive wire (for example, see Patent Document 1 below).

### CITATION LIST

### Patent Document

Patent Document 1: JP 2012-229485 A

### SUMMARY OF THE INVENTION

### Problem to be Solved by the Invention

However, the aluminum alloy conductive wire described in the above-mentioned Patent Document 1 has strength lowered after a heat-resistance test, and there is room for improvement in terms of heat resistance.

The present invention has been conceived in view of the above-mentioned circumstance, and an object of the present invention is to provide an aluminum alloy conductive wire having excellent heat resistance and an electrical wire and a wire harness using the same.

### Means for Solving Problem

The present inventors conducted intensive studies to solve the above-mentioned problems. As a result, the present inventors found that the above-mentioned problems can be solved by an aluminum alloy conductive wire in which content rates of Si, Fe, Cu, and Mg are set to specific ranges, a total content rate of Ti, V, and B is set to be less than or equal to a specific value, and tensile strength and an average crystal grain size are set to be less than or equal to specific values.

That is, the present invention is an aluminum alloy conductive wire which contains 0.15 mass % or more and 0.25 mass % or less of Si, 0.6 mass % or more and 0.9 mass % or less of Fe, 0.05 mass % or more and 0.15 mass % or less of Cu, 0.3 mass % or more and 0.55 mass % or less of Mg, and 0.015 mass % or less in total of Ti, V, and B and has tensile strength of 170 MPa or less, and an average crystal grain size of 5 μm or less.

The aluminum alloy conductive wire of the present invention can have excellent heat resistance.

In the above-mentioned aluminum alloy conductive wire, it is preferable that a total content rate of Ti, V, and B be larger than 0 mass %.

In the above-mentioned aluminum alloy conductive wire, a total content rate of Ti, V, and B may be 0 mass %.

In the above-mentioned aluminum alloy conductive wire, it is preferable that the tensile strength be 130 MPa or more and 165 MPa or less.

In the above-mentioned aluminum alloy conductive wire, it is preferable that the tensile strength be 130 MPa or more and 165 MPa or less, and the average crystal grain size be 3 μm or less.

In this case, it is possible to more sufficiently suppress the tensile strength of the aluminum alloy conductive wire from being excessively increased after the aluminum alloy conductive wire is heated to a high temperature.

In addition, the present invention is an electrical wire including the above-mentioned aluminum alloy conductive wire.

Since the aluminum alloy conductive wire can have excellent heat resistance, the electrical wire can have excellent heat resistance.

Further, the present invention is a wire harness including a plurality of electrical wires described above.

Since the electrical wire can have excellent heat resistance, the wire harness can have excellent heat resistance.

In the present invention, the “average crystal grain size” refers to an average crystal grain size calculated based on the following equation when the aluminum alloy conductive wire of the present invention is cut along a direction orthogonal to the longitudinal direction thereof, a cross section observed at that time is observed by scanning ion microscope (SIM) using a focused ion beam (FIB), ten straight lines parallel to each other are drawn on an SIM image observed at that time, and the number of crystal grains traversed by each straight line is measured.

Average crystal grain size=10×L/N

(In the above equation, L denotes a length of a straight line traversing a crystal grain, and N denotes the total number of crystal grains traversed by all of the straight lines.)

In addition, in the present invention, the “tensile strength” refers to tensile strength measured by a tensile test carried out in accordance with JIS C3002.

### Effect of the Invention

According to the present invention, an aluminum alloy conductive wire having excellent heat resistance, an electrical wire and a wire harness using the same are provided.

### BRIEF DESCRIPTION OF DRAWINGS

FIG. 1 is a cross-sectional view illustrating an embodiment of an aluminum alloy conductive wire of the present invention;

FIG. 2 is a cross-sectional view illustrating an embodiment of an electrical wire of the present invention; and

FIG. 3 is a cross-sectional view illustrating an embodiment of a wire harness of the present invention.

### MODE(S) FOR CARRYING OUT THE INVENTION

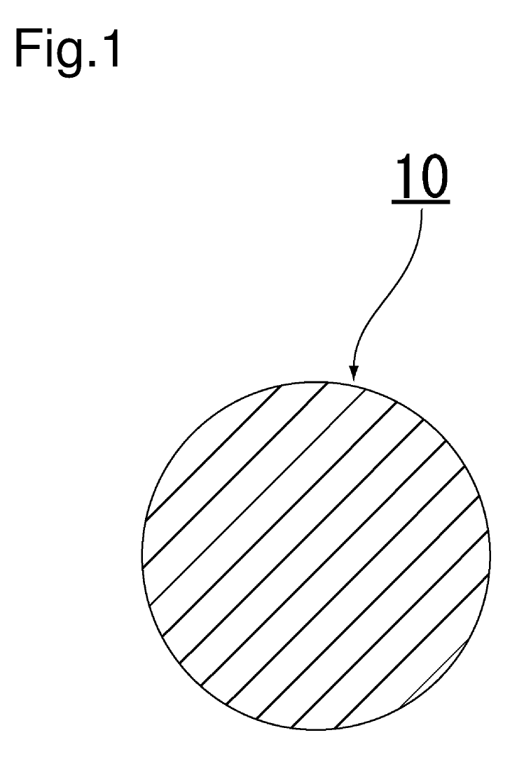

Hereinafter, an embodiment of an aluminum alloy conductive wire of the present invention will be described with reference to FIG. 1. FIG. 1 is a cross-sectional view illustrating the embodiment of the aluminum alloy conductive wire of the present invention.

<Aluminum Alloy Conductive Wire>

As illustrated in FIG. 1, an aluminum alloy conductive wire 10 contains 0.15 mass % or more and 0.25 mass % or less of Si (silicon), 0.6 mass % or more and 0.9 mass % or less of Fe (iron), 0.05 mass % or more and 0.15 mass % or less of Cu (copper), 0.3 mass % or more and 0.55 mass % or less of Mg (magnesium), and 0.015 mass % or less in total of Ti (titanium), V (vanadium), and B (boron) and has tensile strength of 170 MPa or less and an average crystal grain size of 5 μm or less. Here, content rates of Si, Fe, Cu, and Mg and a total content rate of Ti, V, and B are based on the mass of the aluminum alloy conductive wire 10 (100 mass %).

The aluminum alloy conductive wire 10 contains 0.15 mass % or more and 0.25 mass % or less of Si. The content rate of Si is set to 0.15 mass % or more and 0.25 mass % or less since tensile strength and elongation may be balanced with each other when compared to a case in which the content rate of Si is less than 0.15 mass %, and the aluminum alloy conductive wire 10 is excellent in conductivity when compared to a case in which the content rate of Si is more than 0.25 mass %. The content rate of Si is preferably 0.16 mass % or more and 0.22 mass % or less.

The aluminum alloy conductive wire 10 contains 0.6 mass % or more and 0.9 mass % or less of Fe. The content rate of Fe is set to 0.6 mass % or more and 0.9 mass % or less since tensile strength and elongation may be balanced with each other when compared to a case in which the content rate of Fe is less than 0.6 mass %, and the aluminum alloy conductive wire 10 is excellent in conductivity when compared to a case in which the content rate of Fe is more than 0.9 mass %. The content rate of Fe is preferably 0.68 mass % or more and 0.82 mass % or less.

The aluminum alloy conductive wire 10 contains 0.05 mass % or more and 0.15 mass % or less of Cu. The content rate of Cu is set to 0.05 mass % or more and 0.15 mass % or less since tensile strength and elongation may be balanced with each other when compared to a case in which the content rate of Cu is less than 0.05 mass %, and the aluminum alloy conductive wire 10 is excellent in conductivity when compared to a case in which the content rate of Cu is more than 0.15 mass %. The content rate of Cu is preferably 0.06 mass % or more and 0.12 mass % or less.

The aluminum alloy conductive wire 10 contains 0.3 mass % or more and 0.55 mass % or less of Mg. The content rate of Mg is set to 0.3 mass % or more and 0.55 mass % or less since tensile strength and elongation may be balanced with each other when compared to a case in which the content rate of Mg is less than 0.3 mass %, and the aluminum alloy conductive wire 10 is excellent in conductivity when compared to a case in which the content rate of Mg is more than 0.55 mass %. The content rate of Mg is preferably 0.31 mass % or more and 0.52 mass % or less.

In addition, in the aluminum alloy conductive wire 10, the total content rate of Ti, V, and B is 0.015 mass % or less. The total content rate of Ti, V, and B is set to 0.015 mass % or less since the aluminum alloy conductive wire 10 is more excellent in conductivity when compared to a case in which the total content rate of Ti, V, and B is set to be larger than 0.015 mass %. The total content rate of Ti, V, and B is preferably 0.011 mass % or less. The total content rate of Ti, V, and B may be 0.015 mass % or less. Therefore, the total content rate of Ti, V, and B may be 0 mass % or larger than 0 mass %. However, the total content rate of Ti, V, and B is preferably larger than 0 mass %.

That the total content rate of Ti, V, and B is 0 mass % means that a content rate of each of Ti, V, and B is 0 mass %. In addition, when the total content rate of Ti, V, and B is larger than 0 mass %, only the content rate of Ti among Ti, V, and B may be 0 mass %, only the content rate of V may be 0 mass %, and only the content rate of B may be 0 mass %.

Further, in the aluminum alloy conductive wire 10, the tensile strength is 170 MPa or less. In this case, more excellent heat resistance is obtained when compared to a case in which the tensile strength exceeds 170 MPa. The tensile strength is preferably 130 MPa or more and 165 MPa or less, and more preferably 135 MPa or more and 160 MPa or less.

Furthermore, in the aluminum alloy conductive wire 10, the average crystal grain size is 5 μm or less. In this case, more excellent heat resistance is obtained when compared to a case in which the average crystal grain size exceeds 5 μm. The average crystal grain size is preferably 3 μm or less, and more preferably 2.5 μm or less. However, the average crystal grain size is preferably 0.5 μm or more, and more preferably 1 μm or more. In this case, the elongation of the aluminum alloy conductive wire 10 tends to be larger.

In the aluminum alloy conductive wire 10, when the tensile strength is 130 MPa or more and 165 MPa or less, the average crystal grain size is preferably 3 μm or less. In this case, it is possible to more sufficiently suppress the tensile strength of the aluminum alloy conductive wire 10 from being excessively increased after the aluminum alloy conductive wire 10 is heated to a high temperature.

Here, the average crystal grain size is more preferably 2.5 μm or less. However, the average crystal grain size is preferably 0.5 μm or more, and more preferably 1 μm or more. In this case, the elongation of the aluminum alloy conductive wire 10 tends to be larger.

A wire diameter of the aluminum alloy conductive wire 10 is not particularly limited. However, for example, the wire diameter is in a range of 0.14 to 0.45 mm.

<Method of Manufacturing Aluminum Alloy Conductive Wire>

Next, a method of manufacturing the aluminum alloy conductive wire 10 will be described.

The aluminum alloy conductive wire 10 can be obtained by a manufacturing method including a rough drawing wire formation step of forming a rough drawing wire made of an aluminum alloy containing 0.15 mass % or more and 0.25 mass % or less of Si, 0.6 mass % or more and 0.9 mass % or less of Fe, 0.05 mass % or more and 0.15 mass % or less of Cu, 0.3 mass % or more and 0.55 mass % or less of Mg, and 0.015 mass % or less in total of Ti, V, and B, and a processing step of obtaining the aluminum alloy conductive wire 10 by performing a processing process including a heat treatment process and a wire drawing process on the rough drawing wire.

Next, the rough drawing wire formation step and the processing step mentioned above will be described in detail.

[Rough Drawing Wire Formation Step]

The rough drawing wire formation step is a process of forming the rough drawing wire made of the above-mentioned aluminum alloy.

For example, the rough drawing wire can be obtained by performing continuous casting and rolling, hot extrusion after billet casting or the like on molten metal made of the above-mentioned aluminum alloy.

[Processing Step]

The processing step is a step of obtaining the aluminum alloy conductive wire 10 by performing the processing process on the rough drawing wire.

(Processing Process)

The processing process is a process including the wire drawing process and the heat treatment process.

The processing process may include the wire drawing process and the heat treatment process. Examples of a specific aspect of a procedure of the processing process include aspects (1) to (5) below. Here, each process is performed in order from left to right.

(1) heat treatment process→wire drawing process→heat treatment process

(2) heat treatment process→wire drawing process →heat treatment process→wire drawing process→heat treatment process

(3) heat treatment process→wire drawing process→heat treatment process→wire drawing process→heat treatment process→wire drawing process→heat treatment process→wire drawing process→heat treatment process

(4) wire drawing process→heat treatment process→wire drawing process→heat treatment process

(5) wire drawing process→heat treatment process→wire drawing process→heat treatment process→wire drawing process→heat treatment process

However, the procedure of the processing process is not limited to the above aspects. For example, the wire drawing process may be further performed in each of the above specific aspects. In this case, the heat treatment process needs to be performed after the wire drawing process.

The wire drawing process is a process of reducing a diameter of the rough drawing wire, a drawn wire material obtained by drawing the rough drawing wire, a drawn wire material obtained by further drawing the drawn wire material (hereinafter the “rough drawing wire”, the “drawn wire material”, and the “drawn wire material obtained by further drawing the drawn wire material” will be referred to as “wire materials”) or the like. The wire drawing process may be a hot wire drawing or cold wire drawing, and normally be cold wire drawing.

In addition, when a diameter of the wire material subjected to the wire drawing process is large (for example, 3 mm or more), it is preferable to perform heat treatment from the middle to remove distortion generated by wire drawing in the wire drawing process.

The heat treatment process is a process of performing heat treatment on the wire material. In particular, the heat treatment process performed after the wire drawing process is performed to remove distortion generated in the wire material in the wire drawing process.

To set the tensile strength to 170 MPa or less, and set the average crystal grain size to 5 μm or less, a heat treatment temperature in the heat treatment process may normally be set to 350° C. or less, and a heat treatment time in the heat treatment process may normally be set to 1 minute to 18 hours.

In particular, in a heat treatment process finally performed in the heat treatment process (hereinafter referred to as a “final heat treatment process”), it is preferable to perform heat treatment on the wire material at 300° C. or less. In this case, a wire material having a smaller average crystal grain size is obtained when compared to a case in which the heat treatment temperature exceeds 300° C. However, a heat treatment temperature of the wire material in the final heat treatment process is preferably 200° C. or more since strength is more sufficiently lowered.

A heat treatment time in the final heat treatment process is preferably 1 hour or more. In this case, a more uniform wire material is obtained over the entire length when compared to a case in which the heat treatment of the drawn wire material is performed for less than 1 hour. However, the heat treatment time is preferably 12 hours or less.

In addition, in the aluminum alloy, the total content rate of Ti, V, and B may be 0.015 mass % or less. Therefore, the total content rate of Ti, V, and B may be 0 mass % or larger than 0 mass %. However, the total content rate of Ti, V, and B is preferably larger than 0 mass %. In this case, a crack hardly occurs in the rough drawing wire. In addition, disconnection of the wire material hardly occurs in the wire drawing process.

<Electrical Wire>

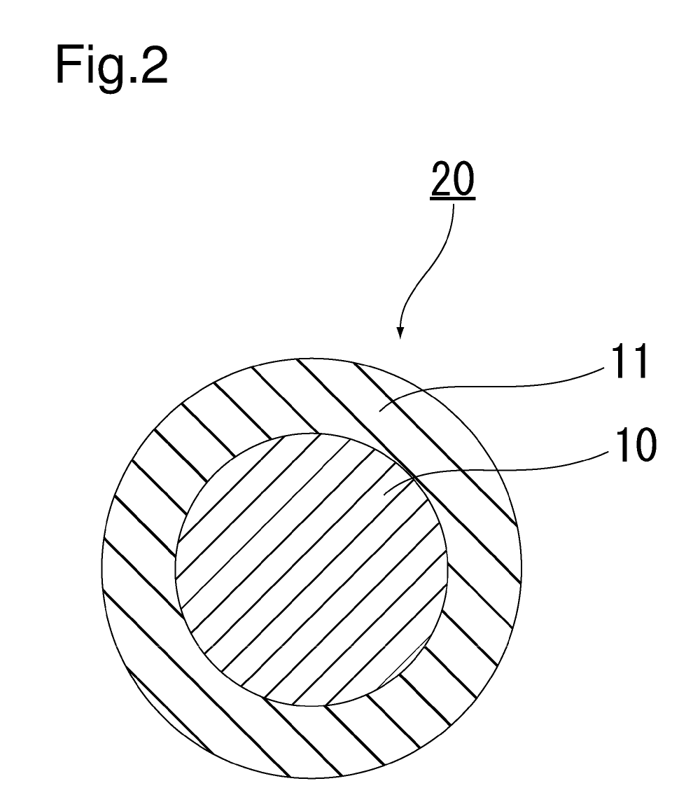

Next, the electrical wire of the present invention will be described with reference to FIG. 2. FIG. 2 is a cross-sectional view illustrating an embodiment of the electrical wire of the present invention.

As illustrated in FIG. 2, the electrical wire 20 includes the above-described aluminum alloy conductive wire 10.

Since the aluminum alloy conductive wire 10 can have excellent heat resistance, the electrical wire 20 can have excellent heat resistance.

Normally, the electrical wire 20 further includes a covering layer 11 that covers the above-mentioned aluminum alloy conductive wire 10. For example, the covering layer 11 is made of a polyvinyl chloride resin or a flame retardant resin composition obtained by adding a flame retardant or the like to a polyolefin resin.

<Wire Harness>

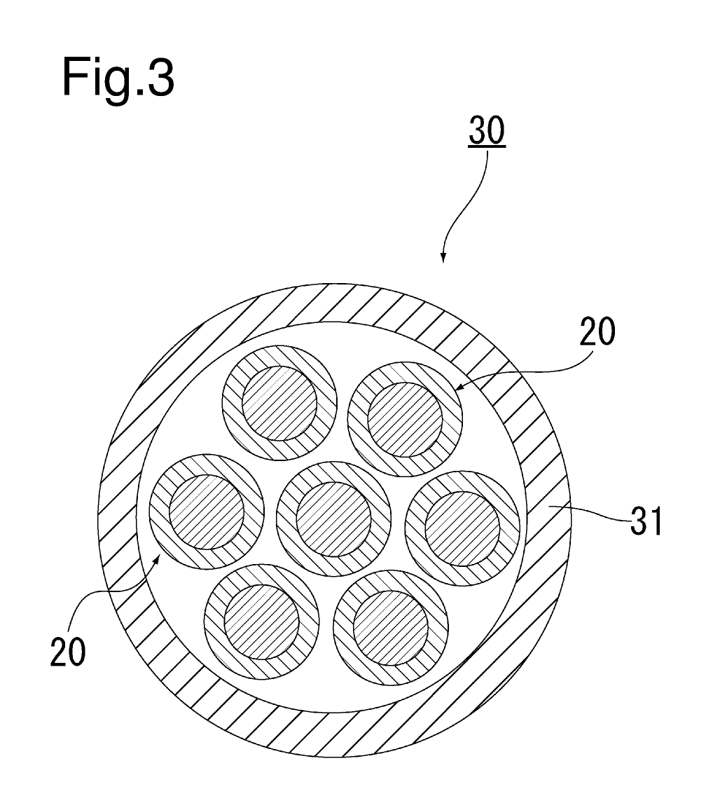

Next, the wire harness of the present invention will be described with reference to FIG. 3. FIG. 3 is a cross-sectional view illustrating an embodiment of the wire harness of the present invention.

As illustrated in FIG. 3, a wire harness 30 includes a plurality of electrical wires 20.

Since the electrical wire 20 can have excellent heat resistance, the wire harness 30 can have excellent heat resistance.

Normally, the wire harness 30 further includes a tape 31 for bundling the electrical wires 20. The tape 31 may be made of the same material as that of the covering layer 11. A tube may be used instead of the tape 31.

### EXAMPLES

Hereinafter, the content of the present invention will be described more specifically using examples and comparative examples. However, the present invention is not limited to the following examples.

### Examples 1 to 28 and Comparative Examples 1 to 23

A rough drawing wire having a wire diameter of 9.5 mm was obtained by dissolving Si, Fe, Cu, Mg, Ti, V and B together with aluminum such that content rates (unit is mass %) shown in Table 1 or 3 are obtained, and performing continuous casting and rolling using the Properzi process. An aluminum alloy conductive wire was obtained by processing the obtained rough drawing wire using the following four types of processing processes A to D.

A: heat treatment at 300° C. for 1 hour→wire drawing up to wire diameter of 3.2 mm→heat treatment at 270° C. for 8 hours→wire drawing up to final wire diameter shown in Table 2 or 4 →heat treatment at temperature and for time of final heat treatment shown in Table 2 or 4

B: heat treatment at 270° C. for 8 hours→wire drawing up to wire diameter of 3.2 mm→heat treatment at 270° C. for 8 hours→wire drawing up to wire diameter of 1.2 mm →heat treatment at 270° C. for 8 hours→wire drawing up to final wire diameter shown in Table 2 or 4 →heat treatment at temperature and for time of final heat treatment shown in Table 2 or 4

C: heat treatment at 300° C. for 1 hour→wire drawing up to final wire diameter shown in Table 2 or 4 →heat treatment at temperature and for time of final heat treatment shown in Table 2 or 4

D: wire drawing up to wire diameter of 3.2 mm→heat treatment at 300° C. for 10 hour→wire drawing up to wire diameter of 1.2 mm→heat treatment at 310° C. for 10 hours →wire drawing up to final wire diameter shown in Table 2 or 4 →heat treatment at temperature and for time of final heat treatment shown in Table 2 or 4

Aluminum alloy conductive wires of Examples 1 to 28 and Comparative Examples 1 to 23 obtained in this way were cut along a direction orthogonal to the longitudinal directions thereof, cross sections observed at that time were observed by SIM using an FIB, ten straight lines parallel to each other were drawn on an SIM image observed at that time, and the number of crystal grains traversed by each straight line was measured. Then, an average crystal grain size was calculated based on the following equation:

Average crystal grain size=10×L/N

(In the above equation, L denotes a length of a straight line traversing a crystal grain, and N denotes the total number of crystal grains traversed by all of the straight lines.)

Results are Shown in Tables 2 and 4.

In addition, a tensile test in accordance with JIS C3002 was carried out on the aluminum alloy conductive wires obtained as described above to measure tensile strengths. Results are shown in Tables 2 and 4.

(Heat Resistance)

A heat-resistance test was carried out on the aluminum alloy conductive wires of Examples 1 to 28 and Comparative Examples 1 to 23 obtained as described above. The heat-resistance test was carried out by holding the aluminum alloy conductive wires at 150° C. for 1,000 hours. Then, the tensile test in accordance with JIS C3002 was carried out on the aluminum alloy conductive wires after the heat-resistance test to measure tensile strengths. Then, a residual rate of tensile strength after the heat-resistance test to tensile strength before the heat-resistance test was calculated based on the tensile strengths before and after the heat-resistance test and an equation below. Results are shown in Tables 2 and 4.

Residual rate (%)=100×tensile strength after heat-resistance test/tensile strength before heat-resistance test

In addition, in Tables 2 and 4, an example in which the residual rate is 95% or more was regarded as having excellent heat resistance, passed, and marked with “O”. In addition, an example in which the residual rate is less than 95% was regarded as being inferior in heat resistance, rejected, and marked with “X” in Tables 2 and 4.

TABLE 1

| | Content rate (mass %) of added element | | | | | | | |
|---|---|---|---|---|---|---|---|---|
| | | | | | | | | Ti + |
| | Si | Fe | Cu | Mg | Ti | V | B | V + B |
| Example 1 | 0.19 | 0.74 | 0.1 | 0.44 | 0.003 | 0.002 | 0 | 0.005 |
| Example 2 | 0.19 | 0.74 | 0.1 | 0.44 | 0.003 | 0.002 | 0 | 0.005 |
| Example 3 | 0.19 | 0.74 | 0.1 | 0.44 | 0.003 | 0.002 | 0 | 0.005 |
| Example 4 | 0.19 | 0.74 | 0.1 | 0.44 | 0.003 | 0.002 | 0 | 0.005 |
| Example 5 | 0.19 | 0.74 | 0.1 | 0.44 | 0.003 | 0.002 | 0 | 0.005 |
| Example 6 | 0.19 | 0.74 | 0.1 | 0.44 | 0.003 | 0.002 | 0 | 0.005 |
| Example 7 | 0.19 | 0.74 | 0.1 | 0.44 | 0.003 | 0.002 | 0 | 0.005 |
| Example 8 | 0.19 | 0.74 | 0.1 | 0.44 | 0.003 | 0.002 | 0 | 0.005 |
| Example 9 | 0.22 | 0.76 | 0.06 | 0.46 | 0.007 | 0.004 | 0 | 0.011 |
| Example 10 | 0.22 | 0.76 | 0.06 | 0.46 | 0.007 | 0.004 | 0 | 0.011 |
| Example 11 | 0.22 | 0.76 | 0.06 | 0.46 | 0.007 | 0.004 | 0 | 0.011 |
| Example 12 | 0.22 | 0.76 | 0.06 | 0.46 | 0.007 | 0.004 | 0 | 0.011 |
| Example 13 | 0.16 | 0.68 | 0.08 | 0.31 | 0.004 | 0 | 0.002 | 0.006 |
| Example 14 | 0.16 | 0.68 | 0.08 | 0.31 | 0 | 0 | 0 | 0 |
| Example 15 | 0.2 | 0.82 | 0.12 | 0.52 | 0.007 | 0 | 0.003 | 0.01 |
| Example 16 | 0.19 | 0.74 | 0.1 | 0.44 | 0.003 | 0.002 | 0 | 0.005 |
| Example 17 | 0.19 | 0.74 | 0.1 | 0.44 | 0.003 | 0.002 | 0 | 0.005 |
| Example 18 | 0.19 | 0.74 | 0.1 | 0.44 | 0.003 | 0.002 | 0 | 0.005 |
| Example 19 | 0.19 | 0.74 | 0.1 | 0.44 | 0.003 | 0.002 | 0 | 0.005 |
| Example 20 | 0.19 | 0.74 | 0.1 | 0.44 | 0.003 | 0.002 | 0 | 0.005 |
| Example 21 | 0.22 | 0.76 | 0.06 | 0.46 | 0.007 | 0.004 | 0 | 0.011 |
| Example 22 | 0.22 | 0.76 | 0.06 | 0.46 | 0.007 | 0.004 | 0 | 0.011 |
| Example 23 | 0.16 | 0.68 | 0.08 | 0.31 | 0.004 | 0 | 0.002 | 0.006 |
| Example 24 | 0.16 | 0.68 | 0.08 | 0.31 | 0.004 | 0 | 0.002 | 0.006 |
| Example 25 | 0.16 | 0.68 | 0.08 | 0.31 | 0 | 0 | 0 | 0 |
| Example 26 | 0.16 | 0.68 | 0.08 | 0.31 | 0 | 0 | 0 | 0 |
| Example 27 | 0.2 | 0.82 | 0.12 | 0.52 | 0.007 | 0 | 0.003 | 0.01 |
| Example 28 | 0.2 | 0.82 | 0.12 | 0.52 | 0.007 | 0 | 0.003 | 0.01 |

TABLE 2

| | | | | | | | After heat- | | |
|---|---|---|---|---|---|---|---|---|---|
| | | | | | After final | | resistance | | |
| | | Final | Final heat | | heat treatment | | test | | |
| | | wire | treatment | | Tensile | Average crystal | Tensile | Residual | |
| | Processing | diameter | Temperature | Time | strength | grain size | strength | rate | |
| | process | (mm) | (° C.) | (h) | (MPa) | (μm) | (MPa) | (%) | Determination |
| Example 1 | A | 0.33 | 230 | 18 | 163.3 | 1.1 | 161.1 | 98.7 | ◯ |
| Example 2 | A | 0.33 | 260 | 8 | 153.3 | 1.3 | 153.4 | 100.1 | ◯ |
| Example 3 | B | 0.33 | 300 | 0.0167 | 149.4 | 1.0 | 148.8 | 99.6 | ◯ |
| Example 4 | B | 0.33 | 220 | 8 | 147.0 | 1.5 | 146.9 | 99.9 | ◯ |
| Example 5 | A | 0.33 | 300 | 3 | 145.3 | 1.8 | 144.1 | 99.2 | ◯ |
| Example 6 | B | 0.33 | 250 | 0.5 | 144.1 | 2.0 | 144.4 | 100.2 | ◯ |
| Example 7 | B | 0.33 | 280 | 8 | 127.2 | 4.0 | 128.3 | 100.9 | ◯ |
| Example 8 | C | 0.33 | 260 | 18 | 145.0 | 1.5 | 145.2 | 100.1 | ◯ |
| Example 9 | B | 0.33 | 270 | 8 | 124.9 | 3.3 | 125.6 | 100.6 | ◯ |
| Example 10 | B | 0.33 | 200 | 8 | 156.0 | 1.2 | 155.8 | 99.9 | ◯ |
| Example 11 | D | 0.33 | 270 | 8 | 126.0 | 3.4 | 126.7 | 100.6 | ◯ |
| Example 12 | D | 0.33 | 250 | 8 | 133.0 | 2.9 | 133.3 | 100.2 | ◯ |
| Example 13 | C | 0.33 | 260 | 3 | 139.8 | 2.2 | 138.8 | 99.3 | ◯ |
| Example 14 | C | 0.33 | 260 | 3 | 139.1 | 2.4 | 137.4 | 98.8 | ◯ |
| Example 15 | C | 0.33 | 240 | 3 | 151.4 | 1.4 | 151.6 | 100.1 | ◯ |
| Example 16 | B | 0.42 | 220 | 8 | 149.6 | 1.4 | 149.7 | 100.1 | ◯ |
| Example 17 | B | 0.21 | 220 | 8 | 146.8 | 1.7 | 147.3 | 100.3 | ◯ |
| Example 18 | B | 0.145 | 220 | 8 | 147.3 | 1.6 | 147.0 | 99.8 | ◯ |
| Example 19 | C | 0.42 | 260 | 18 | 145.6 | 1.4 | 145.3 | 99.8 | ◯ |
| Example 20 | C | 0.145 | 260 | 18 | 143.6 | 1.7 | 144.9 | 100.9 | ◯ |
| Example 21 | D | 0.21 | 270 | 8 | 126.8 | 3.2 | 127.1 | 100.2 | ◯ |
| Example 22 | D | 0.145 | 270 | 8 | 125.5 | 3.6 | 125.4 | 99.9 | ◯ |
| Example 23 | C | 0.42 | 260 | 3 | 140.2 | 2.0 | 139.9 | 99.8 | ◯ |
| Example 24 | C | 0.145 | 260 | 3 | 141.1 | 2.4 | 141.2 | 100.1 | ◯ |
| Example 25 | C | 0.42 | 260 | 3 | 139.6 | 2.6 | 136.9 | 98.1 | ◯ |
| Example 26 | C | 0.21 | 260 | 3 | 138.8 | 2.3 | 137.0 | 98.7 | ◯ |
| Example 27 | C | 0.21 | 240 | 3 | 150.0 | 1.6 | 150.8 | 100.5 | ◯ |
| Example 28 | C | 0.145 | 240 | 3 | 152.1 | 1.5 | 151.6 | 99.7 | ◯ |

TABLE 3

| | Content rate (mass %) of added element | | | | | | | |
|---|---|---|---|---|---|---|---|---|
| | | | | | | | | Ti + |
| | Si | Fe | Cu | Mg | Ti | V | B | V + B |
| Comparative | 0.19 | 0.74 | 0.1 | 0.44 | 0.003 | 0.002 | 0 | 0.005 |
| Example 1 | | | | | | | | |
| Comparative | 0.19 | 0.74 | 0.1 | 0.44 | 0.003 | 0.002 | 0 | 0.005 |
| Example 2 | | | | | | | | |
| Comparative | 0.19 | 0.74 | 0.1 | 0.44 | 0.003 | 0.002 | 0 | 0.005 |
| Example 3 | | | | | | | | |
| Comparative | 0.19 | 0.74 | 0.1 | 0.44 | 0.003 | 0.002 | 0 | 0.005 |
| Example 4 | | | | | | | | |
| Comparative | 0.19 | 0.74 | 0.1 | 0.44 | 0.003 | 0.002 | 0 | 0.005 |
| Example 5 | | | | | | | | |
| Comparative | 0.16 | 0.68 | 0.08 | 0.31 | 0.004 | 0 | 0.002 | 0.006 |
| Example 6 | | | | | | | | |
| Comparative | 0.16 | 0.68 | 0.08 | 0.31 | 0 | 0 | 0 | 0 |
| Example 7 | | | | | | | | |
| Comparative | 0.2 | 0.82 | 0.12 | 0.52 | 0.007 | 0 | 0.003 | 0.01 |
| Example 8 | | | | | | | | |
| Comparative | 0.22 | 0.76 | 0.06 | 0.46 | 0.007 | 0.004 | 0 | 0.011 |
| Example 9 | | | | | | | | |
| Comparative | 0.22 | 0.76 | 0.06 | 0.46 | 0.007 | 0.004 | 0 | 0.011 |
| Example 10 | | | | | | | | |
| Comparative | 0.19 | 0.74 | 0.1 | 0.44 | 0.003 | 0.002 | 0 | 0.005 |
| Example 11 | | | | | | | | |
| Comparative | 0.19 | 0.74 | 0.1 | 0.44 | 0.003 | 0.002 | 0 | 0.005 |
| Example 12 | | | | | | | | |
| Comparative | 0.19 | 0.74 | 0.1 | 0.44 | 0.003 | 0.002 | 0 | 0.005 |
| Example 13 | | | | | | | | |
| Comparative | 0.19 | 0.74 | 0.1 | 0.44 | 0.003 | 0.002 | 0 | 0.005 |
| Example 14 | | | | | | | | |
| Comparative | 0.19 | 0.74 | 0.1 | 0.44 | 0.003 | 0.002 | 0 | 0.005 |
| Example 15 | | | | | | | | |
| Comparative | 0.22 | 0.76 | 0.06 | 0.46 | 0.007 | 0.004 | 0 | 0.011 |
| Example 16 | | | | | | | | |
| Comparative | 0.22 | 0.76 | 0.06 | 0.46 | 0.007 | 0.004 | 0 | 0.011 |
| Example 17 | | | | | | | | |
| Comparative | 0.16 | 0.68 | 0.08 | 0.31 | 0.004 | 0 | 0.002 | 0.006 |
| Example 18 | | | | | | | | |
| Comparative | 0.16 | 0.68 | 0.08 | 0.31 | 0.004 | 0 | 0.002 | 0.006 |
| Example 19 | | | | | | | | |
| Comparative | 0.16 | 0.68 | 0.08 | 0.31 | 0 | 0 | 0 | 0 |
| Example 20 | | | | | | | | |
| Comparative | 0.16 | 0.68 | 0.08 | 0.31 | 0 | 0 | 0 | 0 |
| Example 21 | | | | | | | | |
| Comparative | 0.2 | 0.82 | 0.12 | 0.52 | 0.007 | 0 | 0.003 | 0.01 |
| Example 22 | | | | | | | | |
| Comparative | 0.2 | 0.82 | 0.12 | 0.52 | 0.007 | 0 | 0.003 | 0.01 |
| Example 23 | | | | | | | | |

TABLE 4

| | | | | | | | After heat- | | |
|---|---|---|---|---|---|---|---|---|---|
| | | | | | After final | | resistance | | |
| | | Final | Final heat | | heat treatment | | test | | |
| | | wire | treatment | | Tensile | Average crystal | Tensile | Residual | |
| | Processing | diameter | Temperature | Time | Strength | grain size | strength | rate | |
| | process | (mm) | (° C.) | (h) | (MPa) | (μm) | (MPa) | (%) | Determination |
| Comparative | B | 0.33 | 150 | 8 | 231.4 | 1.1 | 172.7 | 74.6 | X |
| Example 1 | | | | | | | | | |
| Comparative | A | 0.33 | 200 | 18 | 197.1 | 0.7 | 177.1 | 89.9 | X |
| Example 2 | | | | | | | | | |
| Comparative | B | 0.33 | 220 | 0.5 | 172.7 | 0.8 | 163.9 | 94.9 | X |
| Example 3 | | | | | | | | | |
| Comparative | B | 0.33 | 450 | 0.167 | 152.5 | 5.1 | 144.5 | 94.8 | X |
| Example 4 | | | | | | | | | |
| Comparative | C | 0.33 | 220 | 18 | 177.0 | 0.9 | 166.0 | 93.8 | X |
| Example 5 | | | | | | | | | |
| Comparative | C | 0.33 | 200 | 3 | 172.4 | 1.3 | 162.3 | 94.1 | X |
| Example 6 | | | | | | | | | |
| Comparative | C | 0.33 | 200 | 3 | 173.6 | 1.5 | 162.1 | 93.4 | X |
| Example 7 | | | | | | | | | |
| Comparative | C | 0.33 | 400 | 3 | 157.9 | 5.3 | 148.7 | 94.2 | X |
| Example 8 | | | | | | | | | |
| Comparative | B | 0.33 | 150 | 8 | 228.4 | 0.9 | 175.6 | 76.9 | X |
| Example 9 | | | | | | | | | |
| Comparative | D | 0.33 | 180 | 8 | 186.2 | 1.2 | 175.1 | 94.0 | X |
| Example 10 | | | | | | | | | |
| Comparative | B | 0.42 | 150 | 8 | 230.5 | 1.0 | 173.4 | 75.2 | X |
| Example 11 | | | | | | | | | |
| Comparative | B | 0.21 | 150 | 8 | 234.0 | 0.9 | 175.7 | 75.1 | X |
| Example 12 | | | | | | | | | |
| Comparative | B | 0.145 | 150 | 8 | 229.8 | 1.1 | 173.1 | 75.3 | X |
| Example 13 | | | | | | | | | |
| Comparative | C | 0.42 | 220 | 18 | 199.8 | 1.0 | 179.0 | 89.6 | X |
| Example 14 | | | | | | | | | |
| Comparative | C | 0.145 | 220 | 18 | 197.3 | 0.8 | 177.8 | 90.1 | X |
| Example 15 | | | | | | | | | |
| Comparative | D | 0.21 | 180 | 8 | 185.4 | 1.2 | 174.6 | 94.2 | X |
| Example 16 | | | | | | | | | |
| Comparative | D | 0.145 | 180 | 8 | 184.9 | 1.4 | 174.2 | 94.2 | X |
| Example 17 | | | | | | | | | |
| Comparative | C | 0.42 | 200 | 3 | 174.3 | 1.5 | 163.0 | 93.5 | X |
| Example 18 | | | | | | | | | |
| Comparative | C | 0.145 | 200 | 3 | 173.0 | 1.3 | 164.2 | 94.9 | X |
| Example 19 | | | | | | | | | |
| Comparative | C | 0.42 | 200 | 3 | 174.7 | 1.6 | 163.3 | 93.5 | X |
| Example 20 | | | | | | | | | |
| Comparative | C | 0.21 | 200 | 3 | 172.9 | 1.3 | 164.1 | 94.9 | X |
| Example 21 | | | | | | | | | |
| Comparative | C | 0.21 | 400 | 3 | 158.3 | 5.2 | 149.4 | 94.4 | X |
| Example 22 | | | | | | | | | |
| Comparative | C | 0.145 | 400 | 3 | 157.6 | 5.5 | 148.3 | 94.1 | X |
| Example 23 | | | | | | | | | |

From the results shown in Table 2, it was found that all of the aluminum alloy conductive wires of Examples 1 to 28 have the residual rate of 95% or more and satisfy a pass criterion in terms of heat resistance. On the other hand, from the results shown in Table 4, it was found that all of the aluminum alloy conductive wires of Comparative Examples 1 to 23 have the residual rate of less than 95% and do not satisfy the pass criterion in terms of heat resistance.

From the above description, it was confirmed that the aluminum alloy conductive wire of the present invention has excellent heat resistance.

EXPLANATIONS OF REFERENCE NUMERALS

10 . . . aluminum alloy conductive wire

20 . . . electrical wire

30 . . . wire harness

1. An aluminum alloy conductive wire containing:
0.15 mass % or more and 0.25 mass % or less of Si,
0.6 mass % or more and 0.9 mass % or less of Fe,
0.05 mass % or more and 0.15 mass % or less of Cu,
0.3 mass % or more and 0.55 mass % or less of Mg, and
0.015 mass % or less in total of Ti, V, and B,
wherein the aluminum alloy conductive wire has:
tensile strength of 170 MPa or less, and
an average crystal grain size of 5 μm or less.

2. The aluminum alloy conductive wire according to claim 1, wherein a total content rate of Ti, V, and B is larger than 0 mass %.

3. The aluminum alloy conductive wire according to claim 1, wherein a total content rate of Ti, V, and B is 0 mass %.

4. The aluminum alloy conductive wire according to claim 1, wherein the tensile strength is 130 MPa or more and 165 MPa or less.

5. The aluminum alloy conductive wire according to claim 4, wherein the tensile strength is 130 MPa or more and 165 MPa or less, and the average crystal grain size is 3 μm or less.

6. An electrical wire comprising the aluminum alloy conductive wire according to claim 1.

7. A wire harness comprising a plurality of electrical wires according to claim 6. 2650594 3
